(19) United States
(12) Patent Application Publication
(10) Pub. No.: US 2014/0112171 A1
(43) Pub. Date: Apr. 24, 2014

(54) NETWORK SYSTEM AND METHOD FOR IMPROVING ROUTING CAPABILITY

(71) Applicant: Babak PASDAR, (US)

(72) Inventor: Babak PASDAR, Jersey City, NJ (US)

(73) Assignee: Mr. Babak PASDAR, Clifton, NJ (US)

(21) Appl. No.: 13/827,940

(22) Filed: Mar. 14, 2013

Related U.S. Application Data
(60) Provisional application No. 61/717,413, filed on Oct. 23, 2012.

(51) Int. Cl. H04L 12/721

(52) U.S. Cl. CPC H04L 45/70
USPC 370/252

(57) ABSTRACT

Described are embodiments of a system, method, and computer program for providing network services to a user site, utilizing a network system including a computer, a processor, memory, and a plurality of Layer 3 devices distributed at a plurality of nodes of the network system along a Layer 2 backbone for connecting the user site with a predetermined destination, the computer comprising and at least one computer readable medium storing thereon computer code which when executed by the at least one computer causes the at least one computer to at least: measure performance of a plurality of paths that connect the plurality of Layer 3 devices, to the predetermined destination; and select a particular path from the plurality of paths to perform packet transmission based on the measured performance of the plurality of paths based on one or more criteria.

### CROSS REFERENCE TO RELATED APPLICATIONS

This application claims priority to U.S. Provisional Patent Application Ser. No. 61/717,413, the entirety of which is incorporated by reference herein.

### FIELD OF INVENTION

This disclosure relates to computer networking.

### DESCRIPTION OF RELATED ART

Computer networks communicate data using packets of data. Packets used in computer network communications contain the originator's source address and the recipient's destination address. Packets are then directed through a variety of devices that make up the network infrastructure. In network packet switching, routing protocols determine the path to a destination via a number of pre-defined factors along with the number of Autonomous Systems (AS) that must be traversed to reach the destination. As a result, routing decisions rely on the number of AS hops and nor actual performance variables with the assumption that the least number of AS hops indicate a best path to a destination. This results in packets taking paths not based on fastest or most reliable paths, resulting in a “Cloud Penalty.”

### SUMMARY

Described are embodiments of a system, method, and computer program for providing network services to a user site, utilizing a network system including a computer, a processor, memory, and a plurality of Layer 3 devices distributed at a plurality of nodes of the network system along a Layer 2 backbone for connecting the user site with a predetermined destination, the computer comprising and at least one computer readable medium storing thereon computer code which when executed by the at least one computer causes at least one computer to at least: measure performance of a plurality of paths that connect the plurality of Layer 3 devices, to the predetermined destination; and select a particular path from the plurality of paths to perform packet transmission based on the measured performance of the plurality of paths based on one or more criteria.

As noted above, packets used in computer network communications contain the originator's source address and the recipient's destination address. Packets are then directed through a variety of devices that make up the network infrastructure. This applies to the Transport Layer (Layer 2) and the Network Layer (Layer 3) through the use of addresses such as MAC and IP addresses or their equivalents. Network infrastructure devices haul these packets throughout the network utilizing various lists to determine how to direct packets to these destinations. These lists can be defined statically or learned from other network infrastructure devices through dynamic means such as routing protocols, (for example, Border Gateway Protocol (BGP)), from other network infrastructure devices that share the devices' known paths to various destinations.

Disparate networks having a collection of prefixes are distinguished by control domains or other methods and are assigned unique designations known as Autonomous Systems (AS). Many Internet Service Providers (ISP) and multi-homed Internet end-points use BGP to make routing decisions on the Internet. BGP maintains a table of IP networks or ‘prefixes’ which designate network reach-ability that is heavily dependent on the number of Autonomous Systems in the path. An exemplary BGP table is shown in FIG. 3. BGP makes routing decisions based on path, network policies and/or rule-sets.

As noted above, in the network packet switching as described above, routing protocols determine the path to a destination via a number of pre-defined factors along with the number of Autonomous Systems (AS) that must be traversed to reach the destination. As a result, routing decisions rely on the number of AS hops and not actual performance variables with the assumption that the least number of AS hops indicate a faster path to a destination, resulting in a “Cloud Penalty.” The system as set forth in the present disclosure leverages multiple distributed interconnected points of ingress/egress, known as Points of Presence (POP), that are also connected to other Autonomous Systems (AS). These POPs represent the interfaces between the network system of the present disclosure and other AS. The present system measures and analyzes the various paths to any destination from each POP of the present system. Analysis includes creating multiple metrics evaluating the actual performance and reliability of a connection, which uses a plurality of factors rather than merely the number of “AS hops”, to determine the “best path” to any destination. As understood by those having ordinary skill in the art, an “AS hop” is an autonomous system that need to be traversed to get to a destination. A “hop” or “Layer 3 hop” refers to a routed hop. A “best path” can comprise a single selected path or a plurality of selected paths. Network devices within a network utilizing the present system as well as other AS that leverage a Network utilizing the present system as transit are armed with one or more recommended path options including a “Best Path” option that represents the fastest, most reliable path with all of these options considering the user's geographic proximity to each POP. Armed with multiple Gateway options, Network Devices can communicate directly with the “Best Path” POP within only one Layer 3 hop within the present system. A network device may include a computer, a server, a laptop, a tablet, a mobile phone, a mobile calculating device, a personal digital assistant, or a router.

According to an embodiment of the present disclosure, a variety of measurements, including latency and reliability, are taken from each POP to various destinations that may traverse multiple other AS.

According to another embodiment of the present disclosure, the measurement data is analyzed and data from each POP is compared to develop multiple geography specific path lists.

According to another embodiment of the present disclosure, depending on the network consumer's geographic location, specific routing data is shared in order to offer the fastest and most reliable path to the destination points.

According to another embodiment of the present disclosure, intelligent performance and reliability metrics are utilized to multiple prefix points to build geography and proximity aware path lists.

According to another embodiment of the present disclosure, the present system and method share intelligence with other devices of its own system and with devices of other AS based on their geography/proximity between the source and destination and vice versa, Latency and throughput between source and the POP, reliability of communication between the source and the POP, latency and throughput between each POP and the destination, and reliability of communication between each POP and the Destination.

According to another embodiment of the present disclosure, the present system and method leverage a hybrid layer 2/3 (transport layer/internet layer) model to deliver packets in a single hop to the POP with the fastest and most reliable path to the destination from the source.

According to another embodiment of the present disclosure, the present system and method allow a user to customize a connection preference based on reliability, latency, throughput or a combination thereof. A user of the present system is also allowed to associate a connection preference with a destination of a connection, an origination of a connection, service type or application associated with the connection. A user of the present system includes a network device, an autonomous System, a home network, a corporate network, or an ISP.

According to another embodiment of the present disclosure, the system and method assign users into various categories and uses the category information to determine the route preferences for a user.

According to another embodiment of the present disclosure, the system and method assign various types to data communications and use the type information to determine the route preferences for the data communications.

### BRIEF DESCRIPTION OF DRAWINGS

FIG. 1 illustrates a system that sends and receives packets using multiple distributed POPs according to an embodiment of the present disclosure.

FIG. 2 illustrates multiple POPs that calculate “Best Path” according to an embodiment of the present disclosure.

FIG. 3 illustrates a BGP table according to an embodiment of the present disclosure.

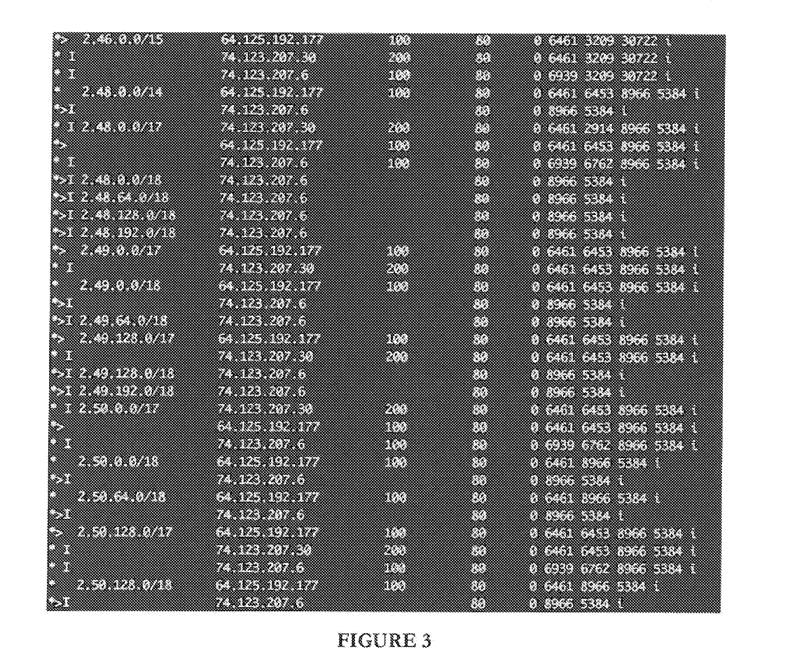

FIG. 4 illustrates an exemplary structure of a server, system, or a terminal according to an embodiment.

### DETAILED DESCRIPTION OF THE INVENTION

The system and method as set forth in the present disclosure use industry standard round-trip measurements that utilize Transmission Control Protocol (TCP) or User Diagram Protocol (UDP) or Internet Control Message Protocol (ICMP) packets to continuously measure the time from when the packet is dispatched to when a response is received, as shown in Table 1. It is noted that these measurements represent the actual performance of connections between a source and a destination, which is different from the route availability and or route flapping used by most current legacy IP networks. The traditional approach measures route availability, which only takes the route advertisement into consideration and not path reliability which would represent packet loss. Current routers track reliability of route advertisement via “flap monitoring” which measures the starting and stopping of route advertisements. This approach does not measure reliability of the path, only reliability and or consistency of the route advertisement.

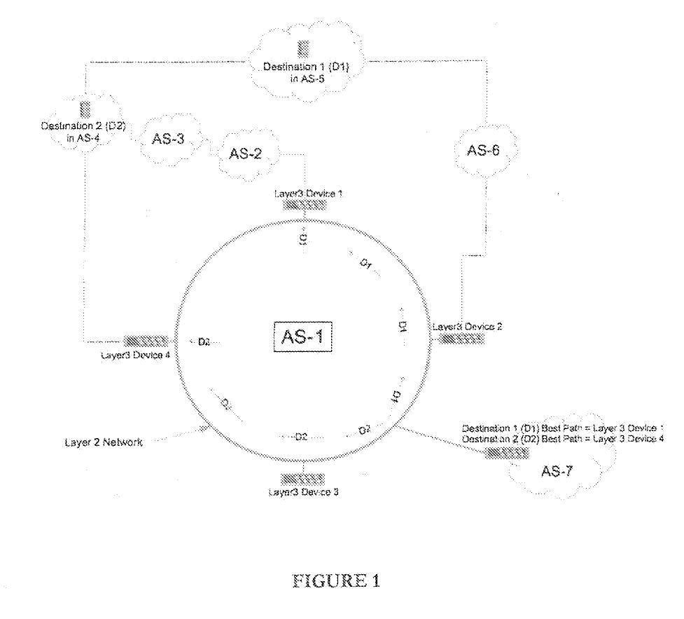

FIG. 1 illustrates a network system according to an embodiment of the present disclosure. The system is configured to send and receive packets using multiple distributed POPs according to an embodiment of the present disclosure. The system AS-1 includes a plurality of distributed layer 3 devices as POPs (Layer 3 Device 1, Layer 3 Device 2, Layer 3 Device 3, and Layer 3 Device 3) which are the ingress and egress points of the network system AS-1. These devices all share a common Layer 2 network. The locations of these devices are carefully selected so that each device is responsible for a predetermined geographical area. The size and coverage of the specified area may vary and can be as small as a floor in a building or as large a country or even continent. For example, Layer 3 Device 4 may be selected to be at the location of a major ISP, ASP, or other software or virtual service provider, and may further be located at a building or campus of that provider. In another example, Layer 3 Device 1 may be located in Seattle, Wash. that provides connection service to all users geographically located close to Seattle and the northwest United States and Southwest Canada, whereas Layer 3 Device 2 can be selected to be located in Los Angles to serve the locations close to Los Angeles. However, as will be described, geography is only one factor, and either device (or another device) may provide the connection to any network destinations based on the AS-1 measurements and other criteria. The four layer 3 devices are connected through a Layer 2 network, forming the network system AS-1. The network system AS-1 is also directly or indirectly connected to other network systems such as AS-2, AS-3, AS-4, AS-5, AS-6, and AS-7. It is noted that the network system AS-1 according to the present disclosure has its own routing algorithm and network policies that improve connection services to users using the network system AS-1.

Each of the Layer 3 devices in the network system AS-1 measures the actual connection performance to various destinations periodically or on demand and shares the measurements among all the. POPs in the network system AS-1. When a user in AS-7 uses the network system AS-1 to connect to Destination 1 (D1) or Destination 2 (D2), the network system AS-1 has pre-determined the best path for the user based on the actual measurements from each POP. Each POP then offers this performance and reliability enhanced routing information derived from its measurements to the network device(s) in AS-7 which are then able to select the best path. According to an embodiment, the network system AS-1 ensures that the user can traverse, or reach any destination within the network system AS-1 within only one hop.

When a user that is connected to network system AS-1 needs to connect to a destination that is reachable via the network system AS-1, the network device(s) on AS-7 are provided with the performance and reliability enhanced routing information from one or more network system AS-1's POPs. The user system now knows the best path to various destinations. The user system is connected to network system AS-1 through a layer 2 network connection and communicates directly with the selected best path layer 3 device on network system AS-1, which allows the user communication to hop out of the network system AS-1 within a single hop.

For example, if the user in the network AS-7 wants to connect to Destination 1 (D1) in AS-5, the network system AS-1 determines that the best path is through AS-2, AS-3, AS-4, and AS-5, the network system AS-1 connects the user with Layer 3 Device 1 so that the user system can hop out of AS-1 through only one connection. It is noted that a traditional legacy network may choose AS-6 as the best path merely based on number of AS hops. The present system first measures the actual performance of all paths, thus making “real time” measurements of the network to determine the best route. However, the system can be configured not to select a route that has high latency or low reliability as a best route. Comparing the legacy network and the network system AS-1, the system AS-1 is consistently faster and more reliable. Testing has shown that the performance of the network system AS-1 could reach four to ten times faster than legacy network systems.

In another example, if a user system wants to connect to Destination 2 (D2) in AS-4, the Layer 3 device in AS-7 may determine that Layer 3 Device 4 is the best path egress point. If so, the user system is subsequently connected to Layer 3 Device 4, via the common layer 2 network, ensuring egress within a single Layer 3 hop.

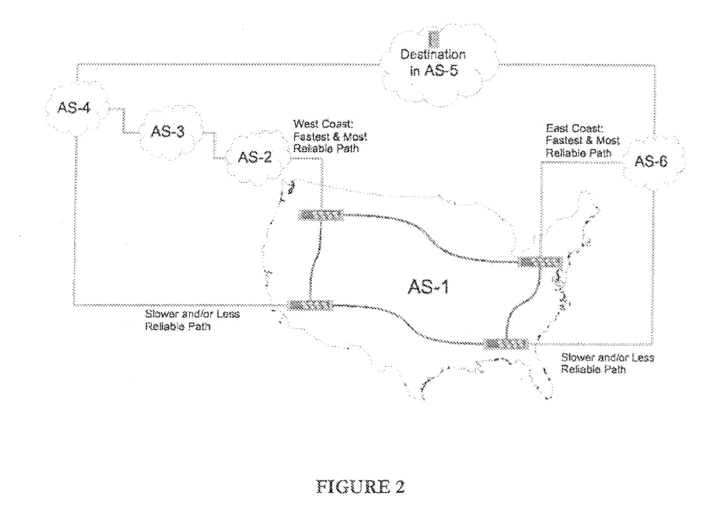

FIG. 2 illustrates exemplary geographical locations of the multiple POPs and factors used in calculating the “best path.” As shown in FIG. 2, the four layer 3 devices may be distributed along the east coast and the west coast of the United States, providing sufficient coverage to the entire country. The present system may include four or more layer 3 devices, each located in well connected facilities such as along the east coast, the west coast, the Midwest, Central US or Alaska within the United States as well as various well connected European, Asia Pacific, Central and South America and African location. Furthermore, the system could facilitate poorly connected regions via various wireless or Satellite platforms. Moreover, any number of Layer 3 devices can be located in a given region or location, which is determined by the needs or preferences for Layer 3 measurement and connectivity as described herein. According to an embodiment, the present system, by default, may use only reliability and latency as two main factors to determine a “best path.” According to another embodiment, the present system may use a plurality of criteria to determine a “best path,” including reliability, latency, throughput, destination, origination, type of communication, user, user category, level of service, and geographical location. It is noted that the present system also provides a plurality of options to networks that utilize the system as a transit, so that these networks have control of the path selection. The plurality of options provided to the users are similar with those used by the system to determine a path.

The present system also improves resilience comparing with the legacy network systems. As shown in FIGS. 1 and 2, the present system includes a plurality of POPs connected by a common layer 2 network. According to an embodiment, each POP normally provides network connectivity service to a specific geographical area in order to distribute and manage the workload of POPs. According to another embodiment, when an outage occurs, each POP may also provide network connecting services to other geographical areas so that a user of the present network can still have network connections. An outage includes a power outage, a hardware outage of a device, a functional outage due to software, or a shutdown of a device. According to another embodiment, as long as one POP is properly functioning, a user of the present network system AS-1 still has network connections.

The present system and method conduct actual performance measurements of connections including using network measurement techniques known in the art. For example, the system and method measure the round-trip time for a request and response to and from various destinations. The system and method also take measurements to determine if there are dropped (that is packets that do not return) or out-of-order packets (packets received in different order than expected) to and from the destination, as shown in Table 1. The system utilizes one or more of ICMP, UDP, or TCP, depending on the most appropriate method to measure round-trip time.

TABLE 1

| | Method | Interact Protocol |
|---|---|---|
| Destination | (TCP/UDP/ICMP) | IPv4/IPv6 |
| x.x.7.7 | UDP | IPv4 |

| IP | | % Loss | % Out-of-order | Current | Average | Best | Worst |
|---|---|---|---|---|---|---|---|
| V4 or | # | by # of | by # of | Millisecond | Millisecond | Millisecond | Millisecond |
| v6 | Seat | Packets | Packets | Latency | Latency | Latency | Latency |
| x.x.1.1 | 10 | 0% | 0 | 0.7 | 0.7 | 0.7 | 1.0 |
| x.x.2.2 | 10 | 0% | 0 | 3.8 | 10.1 | 3.1 | 1214.0 |
| x.x.3.3 | 10 | 0.2% | 0 | 3.6 | 6.0 | 3.2 | 128.5 |
| x.x.4.4 | 10 | 0.2% | 0 | 4.1 | 10.7 | 3.2 | 171.7 |
| x.x.5.5 | 10 | 0.3% | 0 | 4.1 | 5.8 | 3.2 | 127.0 |
| x.x.6.6 | 10 | 0.2% | 0 | 4.3 | 4.3 | 3.3 | 34.9 |
| x.x.7.7 | 10 | 0.2% | 0 | 7.4 | 8.3 | 5.1 | 48.4 |

According to an embodiment, the routing algorithm of the present disclosure takes at three major factors into consideration:
1. Distance/Proximity/Geography (measured in latency) from the communicating site to various Layer 3 POPs.
2. The latency from each POP to the destination.
3. The reliability (measured in number of dropped or out-of-order packets) to the destination.

The following example illustrates an application of the above-identified routing algorithm. In this example, a system according to the present disclosure includes six POPs. When a user site is geographically located in New York, its access time to the six POPs managed by the present system has been measured to be the following:
Access to POP1 is 1 ms
Access to POP2 is 2 ms
Access to POP3 is 5 ms
Access to POP4 is 17 ms
Access to POP5 is 20 ms
Access to POP6 is 50 ms

It is noted that the six POPs (POP1, POP2, POP3, POP4, POP5, and POP6) may be located at strategically important geographical centers such as New York, Boston, Chicago, Los Angeles, Atlanta, and Dallas). If the user system needs to make a connection to Wikipedia.com, the system already knows the actual connection time between each POP and the destination based on previous measurements.
Access to Wikipedia.com from POP1 is 40 ms
Access to Wikipedia.com from POP2 is 45 ms
Access to Wikipedia.com from POP3 is 45 ms
Access to Wikipedia.com from POP4 is 6 ms
Access to Wikipedia.com from POP5 is 7 ms
Access to Wikipedia.com from POP6 is 3 ms

The present system already knows reliability of connections between each POP and the destination based on previous measurements.
Reliability to Wikipedia from Device/Site through POP1 is 99%
Reliability to Wikipedia from Device/Site through POP2 is 99%
Reliability to Wikipedia from Device/Site through POP3 is 98%
Reliability to Wikipedia from Device/Site through POP4 is 80%
Reliability to Wikipedia from Device/Site through POP5 is 99%
Reliability to Wikipedia from Device/Site through POP6 is 99%

The present system combines the latency and reliability corresponding to each routing option:
4.1—Device/Site through POP1 to Wikipedia.com has 41 ms latency at 99% reliability
4.2—Device/Site through POP2 to Wikipedia.com has 47 ms latency at 99% reliability
4.3—Device/Site through POP3 to Wikipedia.com has 50 ms latency at 98% reliability
4.4—Device/Site through POP4 to Wikipedia.com has 23 ms latency at 80% reliability
4.5—Device/Site through POP5 to Wikipedia.com has 27 ms latency at 99% reliability
4.6—Device/Site through POP6 to Wikipedia.com has 53 ms latency at 99% reliability

The system determines a routing option for the user based on one or more predetermined criteria. For example, the system may define a low reliability threshold at x (eg: 90%) and a high latency threshold at y (eg: 100 ms). The system calculates an end-to-end performance and an end-to-end reliability. In one embodiment, the system may select the fastest path 4.4 at 23 ms but it has a reliability of only 80%. The system may select a relatively fast but the most reliable path 4.5 at 27 ms.

Other path selection criteria can be selected for the system or the user may prefer speed, reliability, speed so long as reliability is above the reliability threshold limit, reliability so long as speed is lower the latency threshold limit, or the fastest most reliable path. The system also provides downstream networks the option to choose their preference, for example, prefer speed at all costs prefer reliability at all costs, prefer speed so on as reliability is above a specified threshold, prefer reliability so long as speed is faster than a specified threshold, take the fastest most reliable path. These options can be defined for all destinations, specified destinations, specific Sources to Destinations. The system may allow combinations of one approach, for all and specific for others by destination, one approach for all and specific for others by source, or one approach for all and specific for others by source/destination pairing.

According to an embodiment, the present system may categorize users into different categories such as media provider, communication provider, storage center, document sharing provider, and consumers. The present system may set a path selection option based on the general preference of users in each category. Media providers and communication providers may prefer speed. Storage center may prefer reliability. Consumers may prefer a compromise between speed and reliability.

According to an embodiment, the present system may provide a path selection based on a type of communication, if the type of communication is a specific protocol or application such as SIP for VOIP communications or iSCSI used for storage the system may leverage pre-existing reliability or latency settings that apply to the specific protocols.

It is noted that in this disclosure and particularly in the claims and/or paragraphs, terms such as “comprises,” “comprised,” “comprising,” and the like can have the meaning attributed to them in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior in or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The use of the terms “a,” “an,” “at least one,” “one or more,” and similar terms indicate one of a feature or element as well as more than one of a feature. The use of the term “the” to refer the feature does not imply only one of the feature and element.

When an ordinal number (such as “first,” “second,” “third,” and so on) is used as an adjective before a term, that ordinal number is used (unless expressly or clearly specified otherwise) merely to indicate a particular feature, such as to distinguish that particular feature from another feature that is described by the same term or by a similar term.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate). Similarly, where more than one device, article or other product is described herein (whether or not they cooperate), a single device/article may alternatively be used in place of the more than one device or article that is described. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

Embodiments of the present invention may be implemented using one or more processing devices, or processing modules. The processing devices, or modules, may be coupled such that portions of the processing and/or data manipulation may be performed at one or more processing devices and shared. According to an embodiment, each of the terminals, servers, and systems may be, for example, a server computer or a client computer operatively connected to network as described herein, via bi-directional communication channel, or interconnector, respectively, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

Although each of the above described terminal, server, and system may comprise is full-sized computer, the system and method may also be used in connection with mobile devices capable of wirelessly exchanging data with a server over a network such as the Internet. For example, a user system or device may be a wireless-enabled PDA such as an iPhone, an Android enabled smart phone, a Blackberry phone, or another Internet-capable cellular phone.

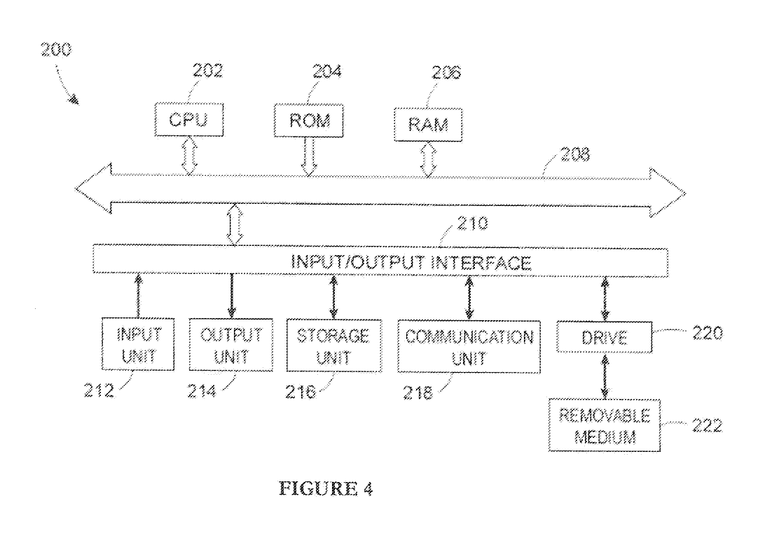

FIG. 4 illustrates an exemplary structure of a server, system, or a terminal according to an embodiment.

The exemplary server, system, or terminal 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interlace 210 is also connected to the bus 208. In addition to the bus 208, the input unit 212, the output unit 214, the storage unit 216, the communication unit 218, and the drive 220 are connected to the input/output interface 210.

The CPU 202, such as an Intel Core™ or Xeon™ series microprocessor or a Freescaler™ PowerPC™ microprocessor, executes various kinds of processing in accordance with a program stored in the ROM 204 or in accordance with a program loaded into the RAM 206 from the storage unit 216 via the input/output interface 210 and the bus 206. The ROM 204 has stored therein a program to be executed by the CPU 202. The RAM 206 stores as appropriate a program to be executed by the CPU 202, and data necessary for the CPU 202 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance.

The input unit 212 includes a keyboard, a mouse, a microphone, a touch screen, and the like. When the input unit 212 is operated by the user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

The communication unit 218 includes a modem, a terminal adaptor, and other communication interfaces, and performs a communication process via the networks of FIGS. 1 and 2.

A removable medium 222 formed of a magnetic disk, an optical disc, a magneto-optical disc, flash or EEPROM, SDSC (standard-capacity) card (SD card), or a semiconductor memory is loaded as appropriate into the drive 220. The drive 220 reads data recorded, on the removable medium 222 or records predetermined data on the removable medium 222.

One skilled in the art will recognize that, although the data storage unit 216, ROM 204, RAM 206 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 202, Input unit 212, communications unit 218, etc.

An operating system such as Microsoft Windows 7®, Windows XP® or Vista™, Linux®, Mac OS®, or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable form-at such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server or transmitted between a plurality of processing devices.

While the invention has been described and illustrated with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

1. A network system, including as computer, a processor, and memory, for providing network services to a user site, comprising:
a plurality of Layer 3 devices distributed at a plurality of nodes of the network system along a Layer 2 backbone for connecting the user site with a predetermined destination,
wherein each of the plurality of Layer 3 devices is configured to measure performance of a plurality of paths that connect the plurality of Layer 3 devices, to the predetermined destination; and
wherein the network system is configured to select a particular path from the plurality of paths to perform packet transmission based on the measured performance of the plurality of paths based on one or more criteria.

2. The network system of claim 1,
wherein the one or more criteria include a latency of each of the plurality of Layer 3 devices, the latency being determined by combining accessing time from the user site to each of the plurality of Layer 3 devices and a connection time between each of the plurality of Layer 3 devices and the predetermined destination.

3. The network system of claim 1,
wherein the one or more criteria include a reliability of each of the plurality of Layer 3 devices, the reliability being determined by measuring packets dropped or out-of-order during the packet transmission between each of the plurality of Layer 3 devices and the destination.

4. The network system of claim 1,
wherein the criteria further include a geographical location of origination, a geographical location of the destination of communication, a service type of communication, a level of service, and a user category.

5. The network system of claim 1,
wherein the system is configured to assign users into a plurality of user categories based on the user preferences, and set a path selection option based on at least one user preference of the users in each of the plurality of user categories.

6. The network system of claim 1,
wherein the measured performance of the plurality of paths is provided to the user site, and at the user site a specific path is selected from one or more paths satisfying the one or more criteria to perform the packet transmission based on at least one user preference.

7. The network system of claim 6,
wherein a predetermined threshold is set for each of a plurality of the criteria, and the paths satisfying the one or more criteria are determined by comparing the measured performance of the plurality of paths with the predetermined threshold for each of the plurality of the criteria.

8. The network system of claim 1,
wherein the measured performance of the plurality of paths is shared among all of the plurality of Layer 3 devices.

9. The network system or claim 1,
wherein the user site is provided with a single hop out of the network system by being directly connected to the node corresponding to the selected particular path through the Layer 2 backbone.

10. The network system of claim 1, further comprising:
utilizing performance and reliability metrics to multiple prefix points to build geography and proximity aware path lists.

11. A method for providing network services to a user site, utilizing a network system including a computer, a processor, memory, and a plurality of Layer 3 devices distributed at a plurality of nodes of the network system along a Layer 2 backbone for connecting the user site with a predetermined destination, the computer comprising and at least one computer readable medium storing thereon computer code which when executed by the at least one computer causes the at least one computer to at least:
measure performance of a plurality of paths that connect the plurality of Layer 3 devices, to the predetermined destination; and
select a particular path from the plurality of paths to perform packet transmission based on the measured performance of the plurality of paths based on one or more criteria.

12. A non-transitory computer-readable recording medium for storing a computer program that executed on a computer for providing network services to a user site, utilizing a network system including a computer, a processor, memory, and a plurality of Layer 3 devices distributed at a plurality of nodes of the network system along a Layer 2 backbone for connecting the user site with a predetermined destination, the program storing thereon computer code which when executed by the at least one computer causes the at least one computer to at least:
measure performance of a plurality of paths that connect the plurality of Layer 3 devices, to the predetermined destination; and
select a particular path from the plurality of paths to perform packet transmission based on the measured performance of the plurality of paths based on one or more criteria.
